(19) United States
(12) Patent Application Publication
(10) Pub. No.: US 2007/0179073 A1
(43) Pub. Date: Aug. 2, 2007

(54) Detergent composition for removing polymerized food soils and method for cleaning polymerized food soils

(76) Inventors: Kim R. Smith, Woodbury, MN (US); Keith E. Olson, Apple Valley, MN (US)

Correspondence Address: ECOLAB INC., MAIL STOP ESC-F7, 655 LONE OAK DRIVE, EAGAN, MN, 55121, US

(21) Appl. No.: 11/595,836

(22) Filed: Nov. 8, 2006

Related U.S. Application Data
(60) Provisional application No. 60/735,789, filed on Nov. 9, 2005.

(51) Int. Cl. C11D 3/00; C11D 3/02

(52) U.S. Cl. 510/197; 510/511

(57) ABSTRACT

A detergent composition includes about 2 wt. % to about 50 wt. % of a first metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is at least about 1.6, and about 0.5 wt. % to about 10 wt. % of a second metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is less than about 1.5. The detergent composition can be used to clean the interior surface of an oven. A method for cleaning polymerized food soil is provided.

### CROSS REFERENCE TO RELATED APPLICATIONS

This application claims priority to U.S. Application Ser. No. 60/735,789 that was filed with the United States Patent and Trademark Office on Nov. 9, 2005. The entire disclosure of U.S. Application Ser. No. 60/735,789 is incorporated herein by reference.

### FIELD OF THE INVENTION

The invention relates to a detergent composition for removing polymerized food soil and to a method for cleaning polymerized food soils from a surface. In particular, the invention relates to an oven cleaning composition and the use of the oven cleaning composition for removing polymerized food soils.

### BACKGROUND OF THE INVENTION

Food soils found on the interior surface of an oven can often be referred to as “polymerized food soils.” In general, the polymerized food soils are the result of cooked-on soils, baked-on soils, or burnt-on soils located on the interior surface of an oven. These soils often result from food spillage, splattering, or vapors generated during cooking of a food product inside of an oven, and over time, the food soil becomes cooked-on, baked-on, or burnt-on.

Oven cleaning compositions often include caustic or sodium hydroxide to penetrate the polymerized soil. Such caustic-based oven cleaning compositions, while being aggressive to the food soil, can be somewhat harmful to skin tissue if the detergent composition contacts skin tissue. In addition, such caustic-based oven cleaning compositions can be harmful to soft metals such as aluminum.

### SUMMARY OF THE INVENTION

A detergent composition is provided according to the invention. The detergent composition includes about 2 wt. % to about 50 wt. % of a first metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is at least about 1.6, and about 0.5 wt. % to about 10 wt. % of a second metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is less than about 1.5. The detergent composition can be used to clean the interior surface of an oven.

A detergent composition that can be provided as a concentrate or a use composition is provided according to the invention. The detergent composition includes the first metal silicate and the second metal silicate at a weight ratio of the first metal silicate to the second metal silicate of about 5:1 to about 75:1.

A method for cleaning polymerized food soil is provided according to the invention. The method includes applying a detergent composition to polymerized food soil on an oven interior surface. The detergent composition can be rinsed from the oven interior surface using water. In addition, the detergent composition can be applied as a foam or gel to the polymerized food soil on an oven interior surface.

### DETAILED DESCRIPTION OF THE INVENTION

A detergent composition is provided for assisting in the removal of polymerized food soils. Polymerized food soils can be found on hard surfaces such as the interior of an oven. In addition, polymerized food soils can be found on soft metals such as aluminum that can be used as griddles and cookware.

The phrase “polymerized food soil” refers to cooked-on food soils, baked-on food soils, or burnt-on food soils that can be found, for example, on the inside surface of an oven that has been used for heating food products by, for example, cooking, baking, or broiling. Polymerized food soils can result from spillage or splattering of food inside an oven and can result from vapors coming off food as it is heated. Polymerized food soils can often be referred to as polymerized/carbonized food soils. In general, polymerized food soils are not easily wiped from a surface, and detergent compositions have been developed to assist in the removal of polymerized food soils. Detergent compositions used for cleaning the interior of an oven are often referred to as “oven cleaners.”

The detergent composition can be provided as a concentrate or as a use composition. When the detergent composition is provided as a concentrate, it can be diluted with water to provide a use composition. The use composition can be applied to a hard surface such as an aluminum surface to assist in the removal of polymerized soils. The use composition can be provided as a foam. The foam can be generated as a result of a mechanical foaming device or by the presence of blowing agents. Providing the composition as a foam can be advantageous to allow a greater contact time of the cleaning composition on the polymerized food soil particularly on vertical surfaces where a liquid composition would have a tendency to fall down. In contrast, a foam can be provided having a greater tendency to hang on a vertical surface and thereby increase contact time of the detergent composition and the polymerized soil.

The detergent composition can include a mixture of different metal silicates. In general, a metal silicate has the following general formula:
MₓO_{y}.mSiO₂.nH₂O
wherein M is at least one of an alkali metal or a transition metal, x and y are independently integers of 1 to 3, m is a number greater than about 0.2, and n is 0 or greater. Exemplary alkali metals include sodium, potassium, magnesium, and lithium. Exemplary transition metals include copper and manganese. Commercially available metal silicates typically have a weight ratio of SiO₂ to MₓO_{y} of about 0.5 to about 4.0. Various metal silicates that can be used are available from the PQ Corporation of Valley Forge, Pa.

The mixture of different metal silicates can include a first metal silicate and a second metal silicate. The first metal silicate can be referred to as a low alkalinity silicate, and the second metal silicate can be referred to as a high alkalinity silicate. In general, the first metal silicate can be included in the detergent composition to provide soft metal safe properties. That is, the first metal silicate can help preserve aluminum that may contact the detergent composition. The second metal silicate can be provided for soil removal properties. By combining the first metal silicate and the second metal silicate, the detergent composition can be provided having a desired level of soil removal properties while resisting damage to soft metals that may contact the detergent composition.

The first metal silicate can be provided having a weight ratio of SiO₂ to MₓO_{y} of at least about 1.6. For the first metal silicate, the weight ratio of SiO₂ to MₓO_{y} can be at least about 2.0, and can be at least about 2.4. The second metal silicate can have a weight ratio of SiO₂ to MₓO_{y} of less than about 1.5. The second metal silicate can have a ratio SiO₂ to MₓO_{y} of less than about 1.2.

The selection of the first metal silicate and the second metal silicate, and the amounts of the first metal silicate and the second metal silicate can provide a detergent composition having a desired level of alkalinity to help penetrate or solubilize a polymerized food soil such as a polymerized food oil/grease soil and protect soft metals that may contact the detergent composition. For example, the detergent composition can be provided as a use composition containing the first metal silicate in an amount of about 2 wt. % to about 50 wt. %, about 5 wt. % to about 45 wt. %, or about 10 wt. % to about 30 wt. %. The detergent composition can be provided as a use composition containing the second metal silicate in an amount of about 0.5 wt. % to about 10 wt. %, about 0.75 wt. % to about 7 wt. %, or about 1 wt. % to about 5 wt. %. The detergent composition, whether a concentrate or use composition, can be selected to provide a desired weight ratio of the first metal silicate relative to the second metal silicate. For example, the detergent composition can have a weight ratio of the first metal silicate to the second metal silicate of about 5:1 to about 75:1, a weight ratio of the first metal silicate to the second metal silicate of about 8:1 to about 50:1, a weight ratio of the first metal silicate to the second metal silicate of about 10:1 to about 30:1, or a weight ratio of the first metal silicate to the second metal silicate of about 13:1 to about 20:1.

The detergent composition can be provided as a concentrate and then diluted to form a use composition. When the detergent composition is provided as a use composition, the solids content can be provided at about 2 wt. % to about 80 wt. %. The solids content refers to the weight percent of the non-water components in the composition. When the detergent composition is provided as a concentrate, the detergent composition can have a solids content of about 5 wt. % to about 100 wt. %. As a liquid or gel concentrate, the detergent composition can have a solids content of about 8 wt. % to about 60 wt. %, or about 10 wt. % to about 40 wt. %. When the concentrate is provided as a solid, the concentrate can have a solids content of about 90 wt. % to about 100 wt. %. The solid concentrate can be diluted to a liquid concentrate or to a liquid use composition. Alternatively, the solid concentrate can be diluted to a gel.

Various cations can be used with the first alkali metal silicate or the second alkali metal silicate. Exemplary cations include potassium, calcium, magnesium, lithium, copper, manganese, or mixture thereof.

The detergent composition can include a surfactant to enhance soil removal properties. In addition, the surfactant can be provided to enhance foaming if it is desirable to provide the detergent composition as a foam. Exemplary surfactants that can be included in the detergent composition include anionic surfactants, cationic surfactants, nonionic surfactants, amphoteric surfactants, or mixtures thereof. Amphoteric surfactants and/or nonionic surfactants are preferred.

Exemplary amphoteric surfactants that can be included in the detergent composition include amine oxides, betaines, derivatives of betaines, sultaines, derivatives of sultaines, amphoacetates, amphocarboxylates, amphopropionates, amphodipropionates, amphoimidazolines, amino acid derivatives, imidazoline derivatives, silicone containing surfactants, or mixtures thereof.

Exemplary nonionic surfactants that can be included in the detergent composition include aliphatic, alkoxylates, aryl alkoxylates, aralkyl alkoxylates, ethylene oxide-propylene oxide copolymers, ethylene oxide-butylene oxide copolymers, fatty amides, fatty esters, polyglycosides, alkyl polyglycosides, silicone containing surfactants, or mixtures thereof.

Exemplary ethylene oxide-propylene oxide polymers include those available under the name Pluronic, Pluronic R, Tetronic, and Tetronic R from BASF. Exemplary nonionic block copolymer surfactants include polyoxyethylene-polyoxypropylene block copolymers. Exemplary polyoxyethylene-polyoxypropylene block copolymers that can be used have the formulae:
(EO)ₓ(PO)_{y}(EO)ₓ
(PO)_{y}(EO)ₓ(PO)_{y}
(PO)_{y}(EO)ₓ(PO)_{y}(EO)ₓ(PO)_{y}
wherein EO represents an ethylene oxide group, PO represents a propylene oxide group, and x and y reflect the average molecular proportion of each alkylene oxide monomer in the overall block copolymer composition. In addition, the nonionic block copolymer surfactants can include additional repeating units such as butylene oxide repeating units. Furthermore, the nonionic block copolymer surfactants that can be used according to the invention can be characterized heteric polyoxyethylene-polyoxypropylene block copolymers. The ethylene oxide-propylene oxide copolymers and the ethylene oxide-butylene oxide copolymers can be capped. The polymers can be alkyl capped, aryl capped, or aralkyl capped. In addition, the polymers can be amine functional.

Exemplary nonionic surfactants that can be used include alcohol alkoxylates, alkylphenol alkoxylates, alkyl amides, alkyl esters, alkyl polyglycosides, alkyl amines, or mixtures thereof. Exemplary alcohol alkoxylates include laureth-7-myristyl polypropoxylate (2PO) and octyl poly(ethoxylate-propoxylate). Exemplary alkylphenol alkoxylates include nonylphenol ethoxylate, dinonylphenol ethoxylates, and octylphenol propoxylate. Exemplary alkyl amids include cocodiethanol amide, stearylmonoethanol amide, and glyceryl amide. Exemplary alkyl esters include alkyl sorbitan ester and polyethylene glycol butyl ester. Exemplary alkyl polyglycosides include octyl polyglycoside and myristyl polyglycoside. An exemplary alkyl amine includes cocodiethanolamine.

Exemplary groups of anionic surfactants include sulfonates and sulfates. Exemplary anionic surfactants that can be included in the detergent composition include ether sulfates, carboxylates, isethionates, phosphates, silicone containing surfactants, alkyl aryl sulfonates, secondary alkane sulfonates, alkyl methyl ester sulfonates, alpha olefin sulfonates, alkyl ether sulfates, alkyl sulfates, alcohol sulfates, or mixtures thereof.

Exemplary alkyl aryl sulfonates that can be used in the cleaning composition can have an alkyl group that contains 6 to 24 carbon atoms and the aryl group can be at least one of benzene, toluene, and xylene. An exemplary alkyl aryl sulfonate includes linear alkyl benzene sulfonate. An exemplary linear alkyl benzene sulfonate includes linear dodecyl benzyl sulfonate that can be provided as an acid that is neutralized to form the sulfonate. Additional exemplary alkyl aryl sulfonates include xylene sulfonate and cumene sulfonate. Exemplary alkane sulfonates that can be used in the cleaning composition can have an alkane group having 6 to 24 carbon atoms. Exemplary alkane sulfonates that can be used include secondary alkane sulfonates. An exemplary secondary alkane sulfonate includes sodium C₁₄-C₁₇ secondary alkyl sulfonate commercially available as Hostapur SAS from Clariant. Exemplary alkyl methyl ester sulfonates that can be used in the cleaning composition include those having an alkyl group containing 6 to 24 carbon atoms. Exemplary alpha olefin sulfonates that can be used in the cleaning composition include those having alpha olefin groups containing 6 to 24 carbon atoms. Exemplary alkyl ether sulfates that can be used in the cleaning composition include those having between about 1 and about 10 repeating alkoxy groups, between about 1 and about 5 repeating alkoxy groups. In general, the alkoxy group will contain between about 2 and about 4 carbon atoms. An exemplary alkoxy group is ethoxy. An exemplary alkyl ether sulfate is sodium lauric ether ethoxylate sulfate and is available under the name Steol CS-460. Exemplary alkyl sulfates that can be used in the cleaning composition include those having an alkyl group containing 6 to 24 carbon atoms. Exemplary alkyl sulfates include sodium lauryl sulfate and sodium lauryl/myristyl sulfate. Exemplary alcohol sulfates that can be used in the cleaning composition include those having an alcohol group containing about 6 to about 24 carbon atoms.

Exemplary cationic surfactants that can be included in the detergent composition include quaternary ammonium compounds, amine salts, amphoteric surfactant salts, amino acid salts, quaternary phosphonium compounds, quaternary sulfonium compounds, silicone derivatives, or mixtures thereof.

The detergent composition can include an organic solvent or a mixture of organic solvents. The organic solvent can be included to enhance foamability, provide a reduced contact angle with soil, improve soil attack properties, or modify the evaporation rate of the detergent composition from a warm surface. Exemplary organic solvents that can be included in the detergent composition include glycerine, glycols (e.g., propylene glycol, ethylene glycol, hexylene glycol), sorbitol, polypropylene glycol, polyacetates, diamines, aliphatic glycol ethers, aryl glycol ethers, aralkyl glycol ethers, aliphatic benzyl alcohol, esters, or mixtures thereof.

The detergent composition can be provided without an organic solvent. For example, the detergent composition can be provided having no organic solvent. When the detergent composition includes an organic solvent, it can be included in the use composition in an amount of about 0.1 wt. % to about 10 wt. %, about 0.5 wt. % to about 7 wt. %, or about 1 wt. % to about 5 wt. %.

The detergent composition can include, if desired, various additional optional components including, for example, viscosity modifiers, fragrances, dyes, pigments, builders, threshold inhibitors for hard water precipitation, solidification aids, bleaches, bleach activators, antimicrobials, pH buffers, and processing aids. Exemplary viscosity modifiers include gums, cellulose derivatives, polyacrylates, copolymers of polyacrylates, polyurethanes, or mixtures thereof. Exemplary builders include aminocarboxylates, phosphonates, phosphates, carbonates, hydroxycarboxylates, dicarboxylates, tricarboxylates, carboxylated polymers, nitriloacetic acid salts, sodium aluminosilicates, or mixtures thereof. Exemplary threshold inhibitors for hard water precipitation include polyacrylates, acrylate copolymers, polymaleic acid, maleic acid copolymers, ethylene oxide-propylene oxide polymers, or mixtures thereof. Exemplary solidification aids include urea, polyethylene glycol, carbonate-phosphonate-water complexes, or mixtures thereof. Exemplary bleaches include chlorine bleach, peroxide bleach, or mixtures thereof. Exemplary processing aids include inorganic fillers, flow aids, extrusion lubricants, anti-cracking agents, or mixtures thereof.

The detergent composition can be provided in various forms including as a liquid, a gel, a paste, a solidified mass (e.g., a block or a pellet or a tablet), or as a powder. When provided as a liquid or gel, the detergent composition can be available as a ready-to-use composition (e.g., a use composition) or can be available as a concentrate for dilution to form a use composition. The location of dilution can be provided at the point of use or at some point upstream such as, for example, at a retail distributor.

The detergent composition can be dispensed by a wide variety of means including liquid spray, aerosol spray, foam, gel, or paste, and can be packaged in a multi-use or unit dose package. The detergent composition can be provided in a container that may be a water-soluble or water dispersible material. Exemplary water-soluble or water-dispersible materials that can be used include those films disclosed in U.S. Pat. Nos. 6,503,879; 6,228,825; 6,303,553; 6,475,977; and 6,632,785, the disclosures of which are incorporated herein by reference. In addition, see U.S. Pat. No. 4,474,976 to Yang, U.S. Pat. No. 4,692,494 to Sonenstein, U.S. Pat. No. 4,608,187 to Chang, U.S. Pat. No. 4,416,793 to Haq, U.S. Pat. No. 4,348,293 to Clarke, U.S. Pat. No. 4,289,815 to Lee, and U.S. Pat. No. 3,695,989 to Albert, the disclosures of which are incorporated herein by reference. An exemplary water soluble polymer that can provide a packaging material that can be used to package the concentrate includes polyvinyl alcohol. The packaged concentrate can be provided as unit dose packages or multiple dose packages.

Suitable water soluble polymers which may be used in the invention are described in Davidson and Sittig, Water Soluble Resins, Van Nostrand Reinhold Company, New York (1968), herein incorporated by reference. The water soluble polymer should have proper characteristics such as strength and pliability in order to permit machine handling. Exemplary water soluble polymers include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcellulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water soluble, polyvinyl alcohol film-forming polymers are generally, preferred. Polyvinyl alcohols that can be used include those having a weight average molecular weight of between about 1,000 and about 300,000, and between about 2,000 and about 150,000, and between about 3,000 and about 100,000.

The detergent composition can be applied to a hard surface (e.g., an oven interior surface) containing a polymerized food soil. The hard surface can be warm (e.g., greater than about 40° C.) or cold (e.g., less than about 40° C.). The detergent composition applied to the hard surface can be agitated to help the detergent composition penetrate the polymerized soil and to help remove the polymerized food soil. The detergent composition can be removed from the hard surface, and can be rinsed from the hard surface by using, for example, water. The hard surface can then be allowed to dry.

The detergent composition, when provided as a use composition for cleaning an oven interior surface, can have the exemplary ranges of components identified in Table 1.

TABLE 1

| | First Range | Second Range | Third Range |
|---|---|---|---|
| Component | (wt. %) | (wt. %) | (wt. %) |
| first silicate | 2-50 | 5-45 | 10-30 |
| second silicate | 0.5-10 | 0.75-7 | 1-5 |
| Surfactant | 0-10 | 0.5-7 | 1-5 |
| organic solvent | 0-10 | 0.5-7 | 1-5 |
| Water | 30-95 | 40-90 | 50-80 |

### EXAMPLE 1

Four compositions were tested for aluminum safety, soil removal by wiping, and soil removal by scrubbing. Composition A includes a mixture of sodium metasilicate (SiO₂/Na₂O=1.0) and sodium silicate (SiO₂/Na₂O=2.4). Composition B contains sodium silicate and no sodium metasilicate, and Composition C contains no sodium metasilicate or sodium silicate. Composition D is a commercially available product under the name Proforce Oven, Fryer and Grill Cleaner from Ecolab Inc. Compositions A-C are reported in Table 2. For compositions A, B, and C, the weight percent of alkalinity source is provided at approximately 18 wt. %.

Two drops of each of Compositions A-D were applied to a film of polymerized corn oil on stainless steel for 1 minute. One drop was then wiped off with a paper towel and the other drop scrubbed with an abrasive pad for a comparative test of ease of removal. Composition A required far less mechanical action than Composition B-D for the removal of the polymerized corn oil.

The compositions were also tested for aluminum compatibility by heating a coupon of aluminum in the solution for 24 hours at 120° F. Composition A was able to retain the aluminum safe properties while exhibiting the desired cleaning properties. Composition A showed better cleaning than Composition B and Composition C (the amine cleaner), and matched the cleaning of Composition D (commercially available sodium hydroxide formula).

TABLE 2

| | Component | | | |
|---|---|---|---|---|
| | A | B | C | D |
| sodium metasilicate, 100% active | 1.1% | 0% | 0% | |
| (SiO₂/Na₂O = 1.0) | | | | |
| sodium silicate, 47% active | 36.5 | 38.7 | 0 | |
| (SiO₂/Na₂O = 2.4) | | | | |
| sodium hydroxide, 50% active | 0 | 0 | 0 | |
| monoethanolamine | 0 | 0 | 18 | |
| cocoamidopropylbetaine, 38% active | 3.7 | 3.7 | 3.7 | |
| butyl carbitol | 1.5 | 1.5 | 1.5 | |
| Water | 57.2 | 56.1 | 76.8 | |
| aluminum safe? | yes | yes | no | no |
| test soil removed by wiping? | yes | no | no | yes |
| test soil removed by scrubbing? | yes | yes | yes | yes |

### EXAMPLE 2

Composition A from Table 2 was used to clean a commercial kitchen oven, which had not been cleaned in several months. The soil on the oven interior surface can be characterized as an extraordinarily heavy polymerized/carbonized soil. The product was applied as a foam, then agitated briefly with a medium scrub pad, and wiped-off followed by a water rinse to remove residual cleaner. A majority of the extraordinarily heavy polymerized/carbonized soil was removed as a result of treatment with Composition A.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A detergent composition comprising:
(a) about 2 wt. % to about 50 wt. % of a first metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is at least about 1.6; and
(b) about 0.5 wt. % to about 10 wt. % of a second metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is less than about 1.5

2. A detergent composition according to claim 1, wherein the detergent composition comprises about 5 wt. % to about 45 wt. % of the first metal silicate and about 0.75 wt. % to about 7 wt. % of the second metal silicate.

3. A detergent composition according to claim 1, wherein the weight ratio of the first metal silicate to the second metal silicate is about 5:1 to about 75:1.

4. A detergent composition according to claim 1, further comprising about 0.5 wt. % to about 10 wt. % of a surfactant.

5. A detergent composition according to claim 4, wherein the surfactant comprises at least one of an amphoteric surfactant or a nonionic surfactant.

6. A detergent composition according to claim 4, wherein the surfactant comprises at least one of aliphatic alkoxylates, aryl alkoxylates, aralkyl alkoxylates, ethylene oxide-propylene oxide copolymers, ethylene oxide-butylene oxide copolymers, fatty amides, fatty esters, polyglycosides, silicone polymers, or mixtures thereof.

7. A detergent composition according to claim 4, wherein the surfactant comprises at least one of amide oxides, betaines, sultaines, amphoacetates, imidazolines, propionates, amino acid derivatives, silicone derivatives, or mixtures thereof.

8. A detergent composition according to claim 1, further comprising about 0.5 wt. % to about 10 wt. % organic solvent.

9. A detergent composition according to claim 8, wherein the organic solvent comprises at least one of glycerine, glycol, sorbitol, aliphatic glycol ether, aryl glycol ether, aralkyl glycol ether, benzyl alcohol, ester, or mixture thereof.

10. A detergent composition according to claim 8, wherein the organic solvent comprises at least one of propylene glycol, ethylene glycol, hexylene glycol, or mixture thereof.

11. A detergent composition according to claim 1, wherein the composition comprises about 30 wt. % to about 95 wt. % water.

12. A detergent composition according to claim 1, wherein the first alkali metal silicate has a value of m of at least about 2.0.

13. A detergent composition according to claim 1, wherein the second alkali metal silicate has an m value of less than about 1.2.

14. A detergent composition comprising:
(a) a first metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is at least about 1.6; and
(b) a second metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is less than about 1.5; and
(c) wherein the weight ratio of the first metal silicate to the second metal silicate is about 5:1 to about 75:1.

15. A method for cleaning polymerized food soil comprising:
(a) applying a detergent composition to polymerized food soil on an oven interior surface, the detergent composition comprising:
(i) about 2 wt. % to about 50 wt. % of a first metal silicate having the formula:
MₓO_{y}.mSiO₂nH₂O
wherein M is at least one of an alkali metal or a transition metal, x and y are independently integers of 1 to 3, m is greater than 0.2, and n is 0 or greater, and the weight ratio of SiO₂ to MₓO_{y} is at least about 1.6; and
(ii) about 0.5 wt. % to about 10 wt. % of a second metal silicate having the formula:
MₓO_{y}.mSiO₂.nH₂O
wherein M is at least one of an alkali metal or a transition metal, x and y are independently integers of 1 to 3, m is greater than 0.2, and n is 0 or greater, and the weight ratio of SiO₂ to MₓO_{y} is less than about 1.5

16. A method according to claim 15, further comprising rinsing the detergent composition from the oven interior surface using water.

17. A method according to claim 15, wherein the step of applying comprises applying a foam or gel of the detergent composition to the polymerized food soil.
